(19) United States
(12) Patent Application Publication
(10) Pub. No.: US 2021/0049586 A1
(43) Pub. Date: Feb. 18, 2021

(54) AUTOMATED TRANSACTION PROCESSING

(71) Applicant: Shtar LLC, Brooklyn, NY (US)

(72) Inventor: Moshe B. Teitelbaum, Brooklyn, NY (US)

(21) Appl. No.: 16/802,553

(22) Filed: Feb. 26, 2020

Related U.S. Application Data
(60) Provisional application No. 62/810,418, filed on Feb. 26, 2019.

(51) Int. Cl. G06Q 20/36; G06Q 20/40; G06Q 20/38

(52) U.S. Cl. CPC G06Q 20/3674; G06Q 20/382; G06Q 20/409

(57) ABSTRACT

Systems and methods are disclosed for automated transaction processing. In one implementation, a transaction initiation notification is received with respect to a first user identifier. One or more operations are initiated in response to the transaction initiation notification. A second user identifier is received. A transaction is generated based on an account identifier associated with the first user identifier and an account identifier associated with the second user identifier. Execution of the generated transaction is initiated.

### CROSS-REFERENCE TO RELATED APPLICATION

This application is related to and claims the benefit of U.S. Patent Application No. 62/810,418, filed Feb. 26, 2019, which is incorporated herein by reference in its entirety.

### TECHNICAL FIELD

Aspects and implementations of the present disclosure relate to data processing and, more specifically, but without limitation, to automated transaction processing.

### BACKGROUND

Existing transaction frameworks can enable users to initiate transactions between one account and another.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 is a flow chart illustrating a method, in accordance with example embodiments, for automated transaction processing.

FIG. 3 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to automated transaction processing.

Existing technologies enable users to users to initiate transactions and other operations between one account and another. However, numerous deficiencies and vulnerabilities remain. For example, existing transaction protocols or frameworks (e.g., payment frameworks such as Automated Clearing House or ‘ACH’) enable transactions to be initiated between two bank accounts. However, such protocols or frameworks provide little or no ability to provide or associated additional information (e.g., in order to provide additional context to a given transaction). As a result, records that are generated and/or maintained with respect to such transactions can be difficult to reconcile, track, audit, investigate, etc. in various scenarios. Additionally, such transactions (or other such operations) may only be executed in ‘batches’ at various intervals (e.g., once or twice a day), resulting in inaccuracies being reflected in account balance(s) even after such transactions have been initiated.

Accordingly, described herein in various implementations are technologies that enable automated transaction processing and other related operations. Using the described technologies, additional identifiers, fields, and/or other information can be generated and associated with respective parties and further utilized to facilitate the secure initiation and execution of a transaction. Additionally, identifiers, fields, etc. can be generated and associated with such transaction(s) in order to facilitate the tracking, reconciliation, etc., of such a transaction (and/or other related operations). These and other features can enable execution of the referenced transaction(s) (and related operations) using existing accounts, services, institutions, transaction frameworks/protocols, etc., while also providing enhanced functionality, security, and efficiency, as well as improved performance, as described herein.

It can therefore be appreciated that the described technologies are directed to and address specific technical challenges and longstanding deficiencies in multiple technical areas, including but not limited to user authentication, transaction processing, and secure operations. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

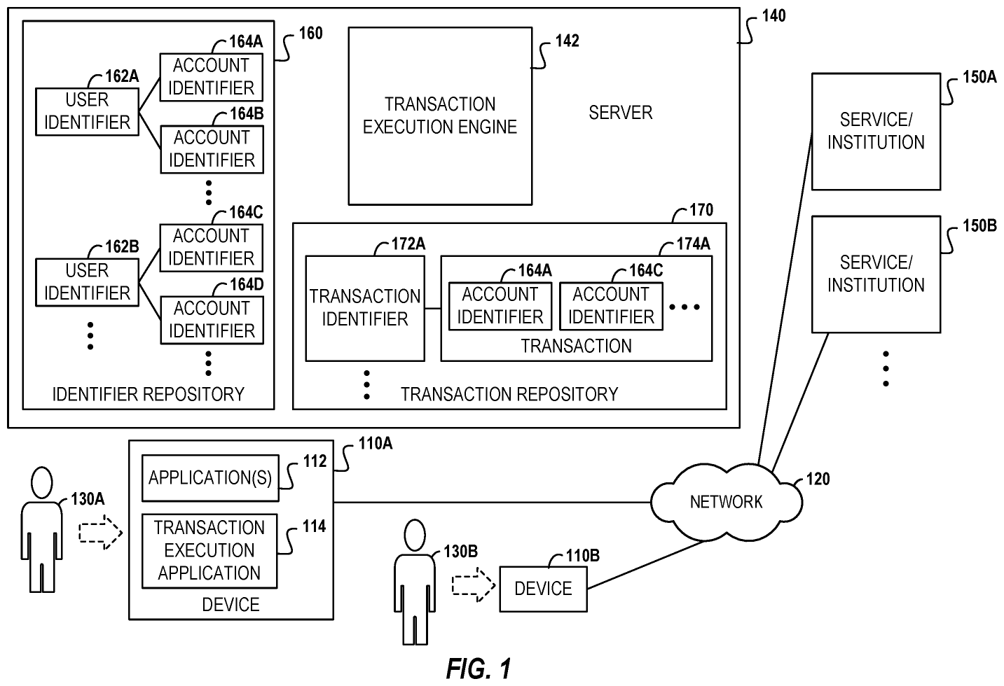

FIG. 1 illustrates an example system 100, in accordance with some implementations. As shown, the system 100 includes components such as device 110A and device 110B (collectively, devices 110). Each of the referenced devices 110 can be, for example, a laptop computer, a desktop computer, a terminal, a mobile phone, a tablet computer, a smart watch, a wearable device, a personal digital assistant (PDA), a digital music player, a connected device, a speaker device, a server, and the like. Users 130A, 130B can be human users who interact with respective device(s) 110. For example, user 130A can provide various inputs (e.g., via an input device/interface such as a keyboard, mouse, touchscreen, microphone, etc.) to device(s) 110A. Device(s) 110A can also display, project, and/or otherwise provide content to user 130A (e.g., via output components such as a screen, speaker, etc.).

As shown in FIG. 1, device(s) 110 can include one or more application(s) 112. Such applications can be programs, modules, or other executable instructions that configure/enable the device to interact with, provide content to, and/or otherwise perform operations on behalf of a user. Examples of such applications include but are not limited to: internet browsers, mobile apps, ecommerce applications, social media applications, personal assistant applications, games, etc. By way of further illustration, application(s) 112 can include mobile apps that enable users to initiate various transactions and/or other operations with third party services 150, such as banking services, food delivery services, ride sharing services, ecommerce services, websites, platforms, etc. By way of yet further illustration, application(s) 112 can include accounting applications, such as those that enable users to track incoming and outgoing payments, transactions, invoices, etc.

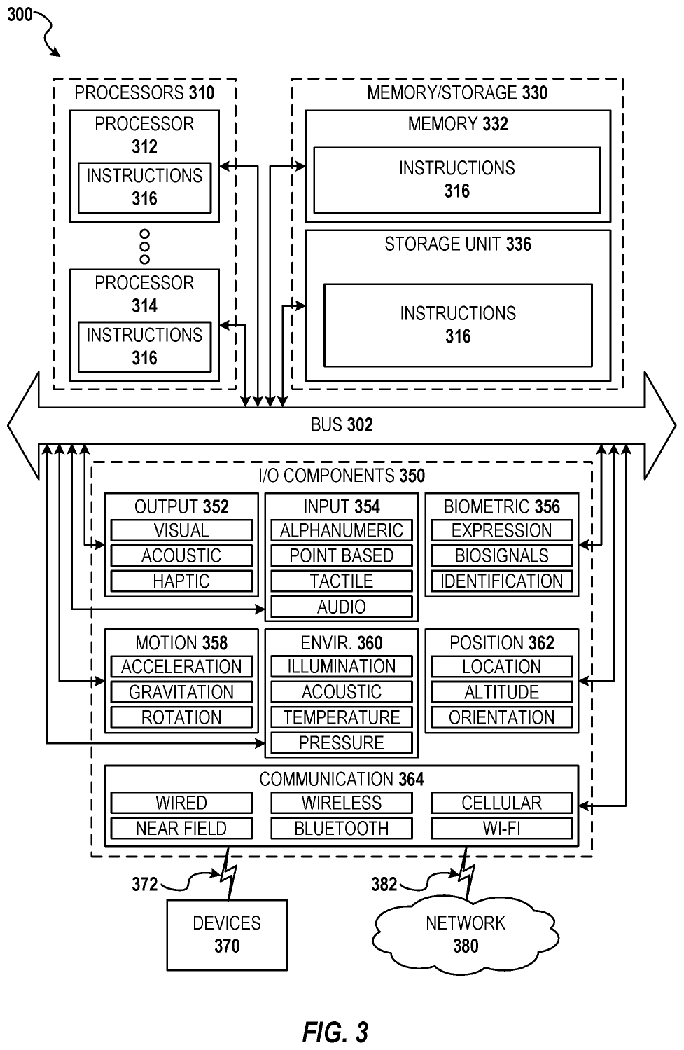

Application(s) 112 can be stored in memory of device 110 (e.g. memory 330 as depicted in FIG. 3 and described below). One or more processor(s) of device 110 (e.g., processors 310 as depicted in FIG. 3 and described below) can execute such application(s). In doing so, device 110 can be configured to perform various operations, present content to user 130, etc.

In certain implementations, device 110 can also include transaction execution application 114. Transaction execution application 114 can be, for example, programs, modules, or other executable instructions that configure/enable the device to initiate/execute transactions in relation to server 140 and/or services 150, generate and/or associate transaction identifiers to such transactions, and/or perform other operations, as described herein. For example, transaction execution application 114 can enable user 130A to generate and assign a transaction identifier to a transaction, as described herein. Such a transaction identifier can, for example, enable other applications, such as accounting applications, to securely and verifiably identify, track, reconcile, and/or perform other operations with respect to such transactions, as described herein.

It should be noted that while application(s) 112 and 114 are depicted and/or described as operating on a device 110, this is only for the sake of clarity. However, in other implementations such elements can also be implemented on other devices/machines. For example, in lieu of executing locally at device 110, aspects of application(s) 112 can be implemented remotely (e.g., on a server device or within a cloud service or framework).

As also shown in FIG. 1, device 110A can connect to and/or otherwise communicate with other device(s) 110B, server 140, and services/institutions 150 via network 120. Network 120 can include one or more networks such as the Internet, a wide area network (WAN), a local area network (LAN), a virtual private network (VPN), an intranet, and the like.

Service/institution 150A and service/institution 150B (collectively, services/institutions 150) can be for example, financial institutions, ecommerce websites, credit/debit card platforms, or other such third-party services with respect to which users 130 may maintain accounts. Such accounts may be associated with account numbers, routing numbers, credit/debit card numbers, and/or other such account identifiers, as described herein. The referenced account identifiers can be used, for example, to enable one user (e.g., user 130A) to initiate a payment or other such transaction or operation to another user (e.g., user 130B). In certain implementations, such transactions can be executed via various payment networks (e.g., ACH) that enable transactions between the respective accounts each user maintains with respective institution(s). In certain implementations, a user 130 can initiate a transaction with such a service/institution via an application (e.g., a web browser or dedicated mobile application) executing on device 110.

Server 140 can be, for example, a server computer, computing device, storage service (e.g., a ‘cloud’ service), etc. that enables operations including the coordination and execution of transactions between parties, as described herein. In certain implementations, server 140 can include transaction execution engine 142.

Transaction execution engine 142 can be an application, module, instructions, etc., that configures/enables the server to perform various operations described herein. In certain implementations, transaction execution engine 142 can securely and verifiably coordinate transactions and other operations between parties and institutions, as described herein. These and other described features, as implemented with respect to server 140 and/or one or more particular machine(s), can improve the functioning of such machine(s) and/or otherwise enhance numerous technologies including enabling and enhancing the security, execution, and management of various transactions, as described herein.

In certain implementations, transaction execution engine 142 can generate and maintain repositories, such as identifier repository 160 and transaction repository 170. Such repositories can be further utilized to enable the secure initiation, processing, and reconciliation of transactions between users and/or respective institutions, and provide various other technical advantages and improvements, as described herein.

Identifier repository 160 can be a storage resource such as an object-oriented database, a relational database, a decentralized or distributed ledger (e.g., blockchain), etc. In certain implementations, identifier repository 160 can maintain records of various user identifiers 162. Such user identifiers can correspond usernames, email addresses, telephone numbers, and/or other custom and/or user-defined fields, etc., each of which may be associated with a respective user 130. For example, in the scenario depicted in FIG. 1, user identifier 162A can correspond to user 130A while user identifier 162B can correspond to user 130B.

Each of the referenced user identifiers 162 can be further associated with one or more account identifiers 164. Each of the referenced account identifiers can correspond to an account such a user maintains, e.g., within one of the referenced services/institutions 150 (e.g., the account number, routing number, credit/debit card number, etc., associated with such an account). For example, as shown in FIG. 1, user identifier 162A (corresponding to user 130A) can be associated with account identifier 164A and account identifier 164B. Each of the referenced account identifiers can correspond to different accounts the user maintains (e.g., within the same and/or different institutions 150). As described herein, the disclosed technologies can enable payments and other secure transactions to be initiated between respective user identifiers. Using identifier repository 160, server 140 can identify or otherwise determine the underlying account identifiers with respect to which such transactions are to be executed. The system can then coordinate the referenced transaction between the respective institutions 150 using the determined account identifiers.

Additionally, in certain implementations various parameters, rules, conditions, and/or other metadata can be defined and/or associated with the referenced user identifiers and/or account identifiers (and/or can be stored in identifier repository 160 in association with various user identifier(s) and/or account identifier(s)). For example, user 130A can define (e.g., with respect to their user identifier 162A) that transactions initiated with respect to a specific user (e.g., payments to user 130B), within a specific date range (e.g., within the month of February), within a defined amount (e.g., below $5,000), etc., are to be initiated with respect to one account identifier (e.g., account identifier 164A), while other transactions initiated under other circumstances are to be initiated with respect to another account identifier (e.g., account identifier 164B). Doing so can, for example, enable the user to efficiently and securely coordinate the execution of transactions with respect to multiple accounts.

By way of further example, user 130B can define (e.g., with respect to their user identifier 162B) that transactions initiated by a specific user (e.g., payments originating from user 130A), within a specific date range (e.g., within the month of March), within a defined amount (e.g., above $5,000), etc., are to be initiated, processed, etc. with respect to one account identifier (e.g., account identifier 164C), while other transactions initiated under other circumstances are to be initiated, processed, etc. with respect to another account identifier (e.g., account identifier 164D). Doing so can, for example, enable the user to efficiently coordinate the routing of incoming transactions with respect to multiple accounts and can further enhance the security of such transactions (by enabling their execution without requiring that the recipient's account information, e.g., routing/account numbers or credit/debit card numbers, and/or other sensitive or identifying information, be provided to the payor).

By way of yet further example, in certain implementations the referenced rules, conditions, etc. can include but are not limited to: entity restriction(s) (e.g., which define the manner with respect to which outgoing and/or incoming transactions directed to a certain user, entity, etc. are to be processed), transaction amount restriction(s) (e.g., which define the manner with respect to which outgoing and/or incoming transactions of a certain amount are to be processed), transaction frequency restriction(s) (e.g., which define the manner with respect to which outgoing and/or incoming transactions occurring at a certain frequency are to be processed), and geographic restriction(s) (e.g., which define the manner with respect to which outgoing and/or incoming transactions initiated at a certain distance from a defined location such as the home of a user are to be processed, which may be determined based on to inputs or determinations originating from various sensors and/or other devices, such as inputs originating from a GPS receiver of one or more devices associated with a user).

In these and other implementations and scenarios, the described technologies can further configure and/or otherwise interact with various sensor(s) to enhance and/or improve the functioning of one or more machine(s). Doing so can enhances the security, execution, and management of various transactions, as described herein. In contrast, existing technologies are incapable of enabling performance of the described operations in a manner that ensures their efficient execution and management, while also maintaining the security and integrity of such transactions, as described herein.

Moreover, in certain implementations the referenced the referenced rules, conditions, etc. can further include or account for or more other transactions (e.g., as stored in transaction repository 170). For example, as described herein, in certain implementations the transaction history of the user that initiated a transaction request and/or of other user(s) can be accounted for in determining the manner in which such a transaction is to be processed (e.g., to determine the underlying account identifiers with respect to which outgoing and/or incoming transactions are to be processed under certain circumstances/scenarios). For example, in scenarios in which such transaction historie(s) reflect that transactions bearing certain characteristics are processed with respect to particular account identifier(s), subsequent transactions, etc., determined to be comparable can be processed accordingly.

It should be understood that the examples provided herein are intended only for purposes of illustration and any number of other implementations are also contemplated. Additionally, the referenced examples (including the described rules and/or other techniques) can be combined in any number of ways. For example, rules/conditions pertaining to a vendor identity, a transaction amount, and a user location, can be combined and utilized with respect to a single transaction. In doing so, the described technologies can enhance and/or improve the functioning of one or more machine(s) and/or increase the security of various transactions, e.g., by ensuring defined rules and conditions are met and that a particular underlying account identifier is utilized to process a transaction/operation under specific circumstances.

As noted, server 140 can also include transaction repository 170. Transaction repository 170 can be, for example, a ledger of various transactions 174 (e.g., financial transactions or other operations) between various users, accounts, entities, etc. Such a ledger can reflect, for example, information corresponding to such transactions, including but not limited to data identifying the user/entity, a transaction amount, a timestamp, etc. For example, as shown in FIG. 1, transaction 174A can be a record reflecting a payment transaction between account identifier 164A (e.g., an account maintained by user 130A at institution 150A) and account identifier 164C (e.g., an account maintained by user 130B at institution 150B).

As also shown in FIG. 1, a transaction identifier 172A can be generated and/or associated with the referenced transaction 174A. Such a transaction identifier can be a unique identifier that enables the respective users 130 to monitor, track, and reconcile various aspects of the execution of the referenced transaction, as described herein. For example, accounting applications can utilize transaction identifier 172A as a reference to reconcile when a particular invoice, payment, etc., has been received. By way of further illustration, transaction identifier 172A can be utilized by accounting and/or other applications to enable further investigation and/or tracking of specific transactions (e.g., to determine whether a particular payment was/wasn't executed, whether a particular transaction is/isn't legitimate, etc.).

While many of the examples described herein are illustrated with respect to multiple machines 110, 140, 150, etc., this is simply for the sake of clarity and brevity. However, it should be understood that the described technologies can also be implemented (in any number of configurations) with respect to a single computing device/service.

Additionally, in certain implementations various aspects of the operations described herein with respect to a single machine (e.g., server 140) can be implemented with respect to multiple machines. For example, in certain implementations identifier repository 160 and transaction repository 170 can be implemented as independent servers, machines, services, etc.

It can be appreciated that the described technologies provide numerous technical advantages and improvements over existing technologies. For example, the described technologies can enable the secure and verifiable execution of the referenced transactions and/or other operations using existing accounts, services, institutions, transaction frameworks/protocols, etc., while also providing enhanced functionality, security, and efficiency, as described herein.

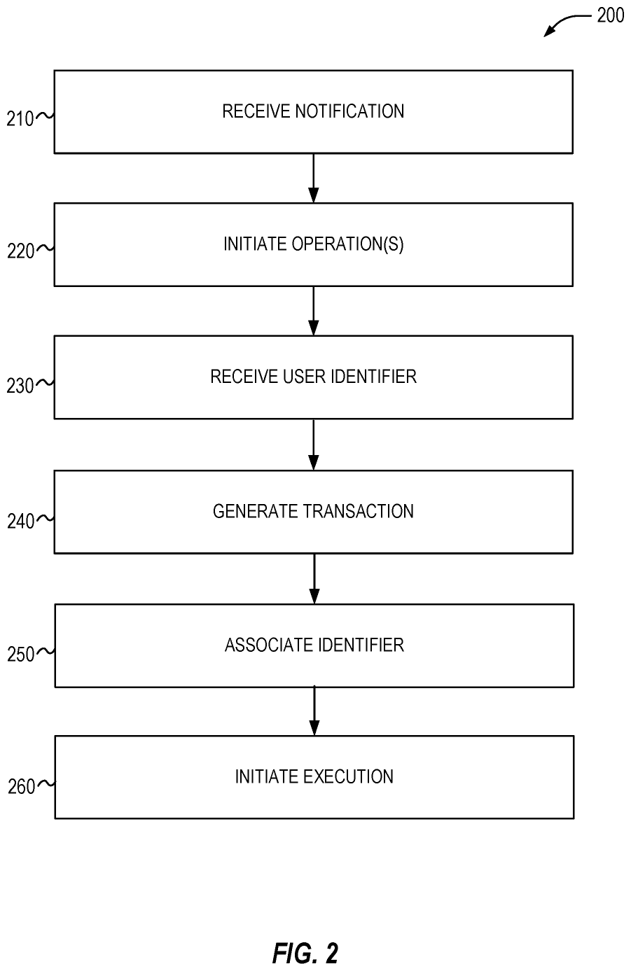

Further aspects and features of server 140 and device(s) 110 and are described in more detail in conjunction with FIGS. 2-3, below.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

FIG. 2 is a flow chart illustrating a method 200, according to an example embodiment, for automated transaction processing. The method is performed by processing logic that can comprise hardware (circuitry, dedicated logic, etc.), software (such as is run on a computing device such as those described herein), or a combination of both. In one implementation, the method 200 is performed by one or more elements depicted and/or described in relation to FIG. 1 (including but not limited to server 140, and/or device(s) 110), while in some other implementations, the one or more blocks of FIG. 2 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 210, a notification is received. In certain implementations, such a notification can be a transaction initiation notification. Such a transaction initiation notification can reflect, for example, that a particular user/user identifier intends to execute a transaction (e.g., an ACH payment transaction, etc.).

By way of illustration, user 130A can generate and/or transmit such a transaction initiation notification via application(s) 112 (e.g., an accounting application or service configured to initiate and/or track incoming and outgoing payments, transactions, invoices, etc.), transaction execution application 114, etc. Such a notification can indicate that the user intends to transmit a payment (e.g., an ACH payment) and may further include an amount (e.g., $1,000). Such a notification may be transmitted to and/or received by server 140.

Moreover, as noted, in certain implementations the referenced transaction can be initiated with respect to a particular user identifier 162. As described herein, such a user identifier may be associated with multiple account identifiers 164, each of which may correspond to a different bank account, etc. In doing so, the user (e.g., user 130A) can initiate a transaction with respect to a single, central interface, and the described technologies can be configured to identify the appropriate account identifier (e.g., an associated personal account, business account, etc.) with respect to which the transaction is to be executed (e.g., the account from which funds for the referenced transaction should be transferred). As noted, such determination(s) can be computed, for example, based on various parameters, metadata, etc., associated with respect to the user identifier and/or respective account identifiers, which define various rules, conditions, etc., with respect to which outgoing and/or incoming transactions are to be processed, as described herein.

As described herein, in certain implementations the referenced rules, conditions, etc. can include but are not limited to: entity restriction(s) (e.g., which define the manner with respect to which outgoing and/or incoming transactions directed to a certain entity are to be processed), transaction amount restriction(s) (e.g., which define the manner with respect to which outgoing and/or incoming transactions of a certain amount are to be processed), transaction frequency restriction(s) (e.g., which define the manner with respect to which outgoing and/or incoming transactions occurring at a certain frequency are to be processed), and geographic restriction(s) (e.g., which define the manner with respect to which outgoing and/or incoming transactions initiated at a certain distance from a defined location such as the home of a user are to be processed).

Moreover, in certain implementations the referenced transaction initiation notification can be processed based on/in relation to or more other transactions (e.g., as stored in transaction repository 170). For example, as described herein, in certain implementations the transaction history of the user that initiated a transaction request and/or of other user(s) can be accounted for in determining the manner in which such a transaction is to be processed (e.g., to determine the underlying account identifiers with respect to which outgoing and/or incoming transactions are to be processed under certain circumstances/scenarios). For example, in scenarios in which such transaction historie(s) reflect that transactions bearing certain characteristics are processed with respect to particular account identifier(s), subsequent transactions, etc., determined to be comparable can be processed accordingly.

It should be understood that the examples provided herein are intended only for purposes of illustration and any number of other implementations are also contemplated. Additionally, the referenced examples (including the described rules and/or other techniques) can be combined in any number of ways. For example, rules/conditions pertaining to a vendor identity, a transaction amount, and a user location, can be combined and utilized with respect to a single transaction. In doing so, the described technologies can enhance and/or improve the functioning of one or more machine(s) and/or increase the security of various transactions, e.g., by ensuring defined rules and conditions are met and that a particular underlying account identifier is utilized to process a transaction/operation under specific circumstances.

At operation 220, one or more operations are initiated. In certain implementations, such operations(s) can be initiated in response to the transaction initiation notification (e.g., as transmitted/received at operation 210). Moreover, in certain implementations such operation(s) can be initiated based on or more rules (e.g., an entity restriction, a transaction amount restriction, a transaction frequency restriction, or a geographic restriction), as described herein. Additionally, in certain implementations the transaction initiation notification can be processed based on or more other transactions, as described herein. Moreover, in certain implementations one or more account identifiers can be identified (e.g., those associated with the first user identifier), as described herein.

For example, in certain implementations, based on a determination that a user has initiated a payment transaction with respect to a particular amount (e.g., $1000), one or more operations can be initiated to place a ‘hold’ or other such restrictions on such funds, e.g., with respect to one or more account(s) associated with the referenced user. It should be understood that such operations may be initiated even in scenarios in which such a transaction is not yet completed or executed. Doing so can be advantageous, for example, in enabling users and/or institutions (e.g., banking institutions) to maintain a real-time availability of funds, even in scenarios in which multiple transactions may be occurring in parallel with respect to a particular account.

Moreover, in certain implementations, a transaction identifier 172 can be generated. As noted, such a transaction identifier can be a unique identifier that enables the respective users 130 to monitor, track, and reconcile various aspects of the execution of a transaction. In certain implementations, such a transaction identifier can be generated and/or provided by user 130A (e.g., the user that initiates the transaction). For example, as shown in FIG. 1, user 130A can initiate a payment transaction (e.g., a payment to be directed to user 130B) via an accounting application 112, transaction execution application 114, etc. In doing so, the user and/or the referenced application(s) can also generate such a transaction identifier 172A which can be used as a reference to facilitate audit, tracking, reconciliation, investigation, and/or other functions associated with such a transaction, as described herein.

At operation 230, a second user identifier is received. In certain implementations, such a user identifier can be received with respect to the referenced transaction initiation notification (e.g., the transaction initiation notification received at operation 210). For example, in the scenario depicted in FIG. 1 and described above, user 130A can generate and/or transmit a transaction initiation notification corresponding to an ACH payment of $1,000 and can further provide a user identifier 162B (e.g., a user ID, email address, telephone number, etc.) corresponding to the recipient of such a transaction (e.g., user 130B).

It should be noted that, as described herein, such a user identifier 162 is not the actual account number, routing number, credit/debit card number, etc. associated with such a recipient. Rather, user 130A may only need to provide a user ID, email address, telephone number, etc., associated with such a recipient. Subsequently, the underlying account information associated with such a recipient can be identified and utilized, as described in detail herein. However, by enabling user 130A (i.e., the sender) to initiate such a transaction without the specific account information of the recipient (user 130B), the security of user 130B's account can be enhanced (by preventing such account information from becoming public, which can increase the risk of fraudulent transactions being initiated). Additionally, doing so can provide considerable technical efficiencies and improvements to existing technologies by enabling the recipient (here, user 130B) to securely substitute accounts, utilize multiple accounts, etc., without needing to provide or coordinate payment details for each circumstance or scenario. Such technologies can also enhance privacy for such users by reducing or eliminating scenarios in which sensitive or personal information is provided to others.

Moreover, in certain implementations the described technologies can be implemented in scenarios in which user 130B (e.g., the intended recipient of a payment transaction) may not initially be reflected or present in identifier repository 160. For example, user 130A may initiate a transaction directed to an email address, phone number, etc. that may not be present in the referenced identifier repository. In such a scenario, a notification can be generated and/or transmitted to such an intended recipient (e.g., via email, text message, etc.) informing the recipient of the transaction and further inviting them to provide one or more account identifiers (e.g., in association with the initially provided user identifier) and/or otherwise provide other enrollment information.

At operation 240, a transaction is generated. In certain implementations, such a transaction can be generated based on an account identifier associated with the first user identifier and an account identifier associated with the second user identifier. In certain implementations, one or more account identifiers associated with the second user identifier can be identified. For example, as described in detail herein, each of the referenced user identifiers 162 (e.g., user accounts that correspond to individual users/entities) can be associated with multiple account identifiers (each of which may correspond to an account such a user maintains, e.g., at a particular service/institution 150). Accordingly, upon receiving a user identifier 162 corresponding to a recipient of a transaction (e.g., at operation 230), a transaction 174 (e.g., a secure transaction or operation) can be generated.

As shown in FIG. 1 and described herein, the referenced transaction 174 can include and/or correspond to specific account identifiers 164. Each of the referenced account identifiers can correspond to the account and/or routing number(s), credit/debit card numbers, etc. of an account that one of the parties to the transaction maintains, e.g., at a service, institution, etc. 150. For example, as shown in FIG. 1, transaction 174A between users 130A and 130B can be executed as an ACH payment between account identifier 164A (e.g., an account associated with user 130A) and account identifier 164C (e.g., an account associated with user 130B).

Additionally, as described herein, the referenced account identifier(s) with respect to which the transaction (e.g., an ACH payment) is to be executed can be identified from among several associated accounts (e.g., an associated personal account, business account, etc.). As noted, both the sender and recipient of the referenced transaction can define various rules, conditions, etc., that dictate which account identifiers are to be used with respect to processing various outgoing and/or incoming transactions. As noted, such rules, conditions, etc. can include entity restriction(s), transaction amount restriction(s), transaction frequency restriction(s), and geographic restriction(s), etc. as described herein.

Based on the referenced parameters, metadata, etc., such the described technologies can determine which account identifier(s) (e.g., which account/routing numbers, credit/debit card numbers, etc.) are to be used with respect to a transaction (e.g., an ACH payment), and can further generate a transaction 174 that includes corresponding payment instructions, commands, etc., generated based on such information.

Moreover, as noted above, in certain implementations the referenced user identifier(s) can include and/or otherwise be associated with various custom and/or user-defined fields. Such custom/user-defined fields can, for example, enable a user to further define and/or control various aspects of the described transactions. For example, a user initiating a transaction can define multiple user identifiers (e.g., an email address, phone number, etc.), each of which can further correspond to different account identifiers. In doing so, by providing one user identifier (e.g., an email address) the user can indicate that a transaction is to be initiated with respect to one account identifier (e.g., a business account) while providing another user identifier (e.g., a phone number) can indicate that a transaction is to be initiated with respect to another account identifier (e.g., a personal account).

Additionally, in certain implementations the referenced user identifier(s) can include and/or otherwise be associated with additional custom and/or user-defined fields. Such custom/user-defined fields can, for example, enable a user to further define and/or control various aspects of the described transactions. For example, a user initiating a transaction can define additional user identifier(s) that supplement a first user identifier (e.g., an email address, phone number, etc.). For example, a user can associate multiple user-defined identifiers with an initial user identifier such as a phone number or email address. Such user-defined identifiers can correspond, for example, to business and personal accounts. In doing so, a user can provide a first user identifier (e.g., an email address) and a second user identifier (e.g., corresponding to a ‘business’ account) to further control the manner in which transactions are initiated, processed, etc., as described herein.

At operation 250, the transaction identifier (e.g., the transaction identifier generated and/or provided by the user that initiated the transaction, e.g., at operation 220) can be associated with the transaction (e.g., the transaction generated at operation 240). For example, as shown in FIG. 1 and described herein, transaction identifier 172A (e.g., the transaction identifier provided by user 130A, e.g., to enable tracking, reconciliation, etc., of the transaction) can be associated with transaction 174A (e.g., a record of the actual ACH payment between the respective accounts of user 130A and user 130B).

At operation 260, execution of the transaction can be initiated. For example, upon generating the referenced transaction 174 (which can include and/or correspond to an ACH payment between the referenced accounts of user 130A and 130B), information of such a transaction can be transmitted to the respective institutions, services, etc., 150 that maintain such accounts. In doing so, the described technologies can enable execution of the referenced transaction using existing accounts, services, institutions, transaction frameworks/protocols, etc., while also providing enhanced functionality, security, and efficiency.

It should also be noted that while the technologies described herein are illustrated primarily with respect to automated transaction processing, the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-2 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 3 is a block diagram illustrating components of a machine 300, according to some example implementations, able to read instructions from a machine-readable medium (e.g., a machine-readable storage medium) and perform any one or more of the methodologies discussed herein. Specifically, FIG. 3 shows a diagrammatic representation of the machine 300 in the example form of a computer system, within which instructions 316 (e.g., software, a program, an application, an applet, an app, or other executable code) for causing the machine 300 to perform any one or more of the methodologies discussed herein can be executed. The instructions 316 transform the non-programmed machine into a particular machine programmed to carry out the described and illustrated functions in the manner described. In alternative implementations, the machine 300 operates as a standalone device or can be coupled (e.g., networked) to other machines. In a networked deployment, the machine 300 can operate in the capacity of a server machine or a client machine in a server-client network environment, or as a peer machine in a peer-to-peer (or distributed) network environment. The machine 300 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 316, sequentially or otherwise, that specify actions to be taken by the machine 300. Further, while only a single machine 300 is illustrated, the term “machine” shall also be taken to include a collection of machines 300 that individually or jointly execute the instructions 316 to perform any one or more of the methodologies discussed herein.

The machine 300 can include processors 310, memory/storage 330, and I/O components 350, which can be configured to communicate with each other such as via a bus 302. In an example implementation, the processors 310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 312 and a processor 314 that can execute the instructions 316. The term “processor” is intended to include multi-core processors that can comprise two or more independent processors (sometimes referred to as “cores”) that can execute instructions contemporaneously. Although FIG. 3 shows multiple processors 310, the machine 300 can include a single processor with a single core, a single processor with multiple cores (e.g., a multi-core processor), multiple processors with a single core, multiple processors with multiples cores, or any combination thereof.

The memory/storage 330 can include a memory 332, such as a main memory, or other memory storage, and a storage unit 336, both accessible to the processors 310 such as via the bus 302. The storage unit 336 and memory 332 store the instructions 316 embodying any one or more of the methodologies or functions described herein. The instructions 316 can also reside, completely or partially, within the memory 332, within the storage unit 336, within at least one of the processors 310 (e.g., within the processor's cache memory), or any suitable combination thereof, during execution thereof by the machine 300. Accordingly, the memory 332, the storage unit 336, and the memory of the processors 310 are examples of machine-readable media.

As used herein, “machine-readable medium” means a device able to store instructions (e.g., instructions 316) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 316. The term “machine-readable medium” shall also be taken to include any medium, or combination of multiple media, that is capable of storing instructions (e.g., instructions 316) for execution by a machine (e.g., machine 300), such that the instructions, when executed by one or more processors of the machine (e.g., processors 310), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 350 can include a wide variety of components to receive input, provide output, produce output, transmit information, exchange information, capture measurements, and so on. The specific I/O components 350 that are included in a particular machine will depend on the type of machine. For example, portable machines such as mobile phones will likely include a touch input device or other such input mechanisms, while a headless server machine will likely not include such a touch input device. It will be appreciated that the I/O components 350 can include many other components that are not shown in FIG. 3. The I/O components 350 are grouped according to functionality merely for simplifying the following discussion and the grouping is in no way limiting. In various example implementations, the I/O components 350 can include output components 352 and input components 354. The output components 352 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 354 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 350 can include biometric components 356, motion components 358, environmental components 360, or position components 362, among a wide array of other components. For example, the biometric components 356 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 358 can include acceleration sensor components (e.g., accelerometer), gravitation sensor components, rotation sensor components (e.g., gyroscope), and so forth. The environmental components 360 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 362 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 350 can include communication components 364 operable to couple the machine 300 to a network 380 or devices 370 via a coupling 382 and a coupling 372, respectively. For example, the communication components 364 can include a network interface component or other suitable device to interface with the network 380. In further examples, the communication components 364 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 370 can be another machine or any of a wide variety of peripheral devices (e.g., a peripheral device coupled via a USB).

Moreover, the communication components 364 can detect identifiers or include components operable to detect identifiers. For example, the communication components 364 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 364, such as location via Internet Protocol (IP) geolocation, location via Wi-Fi® signal triangulation, location via detecting an NFC beacon signal that can indicate a particular location, and so forth.

In various example implementations, one or more portions of the network 380 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 380 or a portion of the network 380 can include a wireless or cellular network and the coupling 382 can be a Code Division Multiple Access (CDMA) connection, a Global System for Mobile communications (GSM) connection, or another type of cellular or wireless coupling. In this example, the coupling 382 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 316 can be transmitted or received over the network 380 using a transmission medium via a network interface device (e.g., a network interface component included in the communication components 364) and utilizing any one of a number of well-known transfer protocols (e.g., HTTP). Similarly, the instructions 316 can be transmitted or received using a transmission medium via the coupling 372 (e.g., a peer-to-peer coupling) to the devices 370. The term “transmission medium” shall be taken to include any intangible medium that is capable of storing, encoding, or carrying the instructions 316 for execution by the machine 300, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving a transaction initiation notification with respect to a first user identifier;
initiating one or more operations in response to the transaction initiation notification;
receiving a second user identifier;
generating a transaction based on an account identifier associated with the first user identifier and an account identifier associated with the second user identifier; and
initiating execution of the transaction.

2. The system of claim 1, wherein initiating one or more operations in response to the transaction initiation notification comprises generating a transaction identifier.

3. The system of claim 2, wherein the memory further stores instructions that, when executed by the processing device, cause the system to perform operations comprising associating the transaction identifier with the transaction.

4. The system of claim 1, wherein initiating one or more operations comprises initiating one or more operations based on or more rules.

5. The system of claim 4, wherein the one or more rules comprises at least one of: an entity restriction, a transaction amount restriction, a transaction frequency restriction, or a geographic restriction.

6. The system of claim 1, wherein initiating one or more operations comprises processing the transaction initiation notification based on or more other transactions.

7. The system of claim 1, wherein initiating one or more operations comprises identifying one or more account identifiers associated with the first user identifier.

8. The system of claim 1, wherein generating a transaction comprises identifying one or more account identifiers associated with the second user identifier.

9. A method comprising:
receiving a transaction initiation notification with respect to a first user identifier;
initiating one or more operations in response to the transaction initiation notification;
receiving a second user identifier;
generating a transaction based on an account identifier associated with the first user identifier and an account identifier associated with the second user identifier; and
initiating execution of the transaction.

10. The method of claim 9, wherein initiating one or more operations in response to the transaction initiation notification comprises generating a transaction identifier.

11. The method of claim 10, further comprising associating the transaction identifier with the transaction.

12. The method of claim 9, wherein initiating one or more operations comprises initiating one or more operations based on or more rules.

13. The method of claim 12, wherein the one or more rules comprises at least one of: an entity restriction, a transaction amount restriction, a transaction frequency restriction, or a geographic restriction.

14. The method of claim 9, wherein initiating one or more operations comprises processing the transaction initiation notification based on or more other transactions.

15. The method of claim 9, wherein initiating one or more operations comprises identifying one or more account identifiers associated with the first user identifier.

16. The method of claim 9, wherein generating a transaction comprises identifying one or more account identifiers associated with the second user identifier.

17. A non-transitory computer readable medium having instructions stored thereon that, when executed by a processing device, cause the processing device to perform operations comprising:
receiving a transaction initiation notification with respect to a first user identifier;
initiating one or more operations in response to the transaction initiation notification;
receiving a second user identifier;
generating a transaction based on an account identifier associated with the first user identifier and an account identifier associated with the second user identifier; and
initiating execution of the transaction.

18. The non-transitory computer readable medium of claim 17, wherein initiating one or more operations in response to the transaction initiation notification comprises generating a transaction identifier.

19. The non-transitory computer readable medium of claim 18, further comprising instructions that, when executed by the processing device, cause the processing device to perform operations comprising associating the transaction identifier with the transaction.

20. The non-transitory computer readable medium of claim 17, wherein initiating one or more operations comprises initiating one or more operations based on or more rules, wherein the one or more rules comprises at least one of: an entity restriction, a transaction amount restriction, a transaction frequency restriction, or a geographic restriction.
